(19) United States
(12) Patent Application Publication
(10) Pub. No.: US 2025/0160349 A1
(43) Pub. Date: May 22, 2025

(54) CASCADE-BASED SYSTEM FOR EFFICIENT THAWING OF FROZEN PRODUCTS

(71) Applicant: CFA PROPERTIES, INC., Atlanta, GA (US)

(72) Inventor: Jonathan BROMER, Atlanta, GA (US)

(21) Appl. No.: 18/953,919

(22) Filed: Nov. 20, 2024

Related U.S. Application Data
(60) Provisional application No. 63/600,912, filed on Nov. 20, 2023.

(51) Int. Cl. A23B 4/06; F28F 25/08

(52) U.S. Cl. CPC A23B 4/064; F28F 25/085

(57) ABSTRACT

Embodiments of the present disclosure relate to a system and method for efficient frozen food thawing. An example system includes a movement mechanism comprising a surface configured to receive a plurality of cascade trays, wherein: the movement mechanism is configured to translate the plurality of cascade trays under a tempered water flow; and a respective cascade tray is configured to accommodate a frozen food product, the tempered water flow configured to induce thawing of the frozen food product. The thawing system may include at least one dispensing mechanism positioned superior to the movement mechanism and configured to emit the tempered water flow toward the surface of the movement mechanism in a direction that causes the tempered water flow to impact the frozen food products in a direction such that the water moves oblique to a movement direction of the movement mechanism.

### CROSS REFERENCE TO RELATED APPLICATIONS

This application claims the benefit of and priority to U.S. Provisional Application No. 63/600,912, filed Nov. 20, 2023, entitled “CASCADE-BASED SYSTEM FOR EFFICIENT THAWING OF FROZEN PRODUCTS,” the disclosure of which is incorporated herein by reference in its entirety.

### TECHNICAL FIELD

This application generally relates to systems and processes for efficiently thawing frozen products, such as poultry.

### BACKGROUND

In quick-service restaurants (QSR), distribution centers (DCs), and/or the like, food products are often obtained frozen and require timely thawing to ensure readiness for preparation. Thawing generally refers to reversing a freezing process by raising the temperature of a consumable to an adequate temperature such that the product may be properly cooked. This has historically been achieved by placing frozen consumables into a thawing chamber inside of which the air temperature is maintained at an appropriate thawing temperature. However, such approaches typically result in a lengthy thawing time, such as 36 hours, which is undesirable in QSRs and DCs where food preparation processes are high volume and require rapid throughput. Approaches to thaw frozen consumables more rapidly may use higher air temperatures or microwave-based apparatuses; however, such techniques may result in uneven thawing, compromised flavor, and incubation of microbes. QSRs and DCs have not yet solved the challenge of efficiently thawing frozen consumables without compromising taste or introducing other adverse effects.

### BRIEF SUMMARY

Embodiments of the present disclosure relate to apparatuses, devices, systems, and methods for efficiently thawing frozen food products via cascading flows of tempered water. An example thawing system may include at least one continuous movement mechanism comprising a surface configured to receive a plurality of cascade trays. The at least one continuous movement mechanism may be configured to translate the plurality of cascade trays under a tempered water flow. A respective cascade tray may be configured to accommodate a frozen food product, the tempered water flow configured to induce thawing of the frozen food product. The thawing system may further comprise at least one dispensing mechanism positioned superior to the at least one continuous movement mechanism and configured to emit the tempered water flow toward the surface of the at least one continuous movement mechanism in a direction that causes the tempered water flow to impact the frozen food product in a direction such that the water moves oblique to a movement direction of the at least one continuous movement mechanism.

In some embodiments, the at least one dispensing mechanism comprises at least one panel configured to receive and deflect the tempered water flow in the direction oblique to the movement direction of the at least one continuous movement mechanism. In some embodiments, the at least one panel is configured to cause the tempered water flow to contact the plurality of frozen products at an oblique angle relative to a plane extending along the surface of the at least one continuous movement mechanism. In some embodiments, the at least one panel comprises a flow panel configured to: receive the tempered water flow; and direct the tempered water flow onto a deflection panel. In some embodiments, the deflection panel is configured to direct the tempered water flow onto the plurality of frozen products at the oblique angle. In some embodiments, the flow panel comprises a first slope; and the deflection panel comprises a second slope that is less than the first slope.

In some embodiments, the at least one dispensing mechanism comprises a reservoir configured to temporarily contain a volume of the tempered water flow; and the at least one panel is configured to receive the tempered water flow from the reservoir as the volume of the tempered water flow rises above a top surface of a sidewall of the reservoir. In some embodiments, the top surface of the sidewall comprises a lip configured to define a convex transition from the top surface to the at least one panel.

In some embodiments, a respective dispensing mechanism is positioned off-center from a respective centerline of at least a subset of the plurality of cascade trays to cause the tempered water flow to translate along respective top surfaces of the plurality of frozen food products. In some embodiments, the at least one continuous movement mechanism comprise a chain-link conveyor belt. In some embodiments, the surface of the at least one continuous movement mechanism comprises a plurality of voids and is configured to enable the tempered water flow to pass through the at least one continuous movement mechanism via the plurality of voids.

In some embodiments, a respective cascade tray defines a reservoir configured to temporarily containing a volume of water from the tempered water flow. In some embodiments, the cascade tray comprises a plurality of voids configured to enable passage of the volume of water through a bottom surface of the cascade tray such that additional volumes of water from the tempered water flow are temporarily contained within the reservoir. In some embodiments, the plurality of voids are distributed along a perimeter of the bottom surface of the cascade tray. In some embodiments, the bottom surface of the cascade tray comprises a first side configured to contact the respective frozen food product and a second side configured to contact the surface of the at least one continuous movement mechanism; and the second side comprises at least one textured feature configured to increase friction between the cascade tray and the surface of the at least one continuous movement mechanism.

In some embodiments, the thawing system further comprises a reservoir beneath the at least one continuous movement mechanism and configured to collect an outflow of the tempered water flow; an outlet configured to connect the outflow of the tempered water flow to a filtration system configured to output a filtered water supply to a heating apparatus; the heating apparatus configured to generate tempered supply water from the filtered water supply; and a manifold configured to generate the tempered water flow and circulate the tempered water flow to the at least one dispensing mechanism. In some embodiments, a respective dispensing mechanism comprises a plurality of outlets spaced apart from one another, a respective outlet being configured to direct a subset of the tempered water flow toward a subset of the surface of the at least one continuous movement mechanism.

In some embodiments, the thawing system further comprises a first elevator proximate to a first end of the at least one continuous movement mechanism and configured to: receive at least one frozen food product; raise or lower the at least one frozen food product to a horizontal position in alignment with the surface of the at least one continuous movement mechanism; and translate the at least one frozen food product onto the surface of the at least one continuous movement mechanism. In some embodiments, the thawing system further comprises a second elevator proximate to a second end of the at least one continuous movement mechanism and configured to, subsequent to thawing of the at least one frozen food product via the tempered water flow: receive the at least one thawed food product from the at least one continuous movement mechanism; raise or lower the at least one thawed food product to a horizontal position in alignment with a surface a storage apparatus; and translate the at least one thawed food product onto the surface of the storage apparatus. In some embodiments, the at least one dispensing mechanism comprises a plurality of dispensing mechanisms spaced apart from one another along an axis extending parallel to a movement direction of the at least one continuous movement mechanism.

An example method for efficiently thawing frozen food products may include advancing a plurality of cascade trays beneath a first segment of a dispensing mechanism via a continuous movement mechanism, wherein a respective cascade tray comprises a frozen food product. The method may include outputting, via the dispensing mechanism, a cascading flow of tempered water onto the plurality of frozen food products and the plurality of cascade trays, wherein: the cascading flow of tempered water is configured to apply a thermal gradient the plurality of frozen products to induce thawing; the respective cascade tray is configured to temporarily contain a first volume of the tempered water; and the first volume of tempered water is configured to increase exposure of a respective frozen food product to the thermal gradient. The method may include advancing the plurality of cascade trays beneath a second segment of the dispensing mechanism via the continuous movement mechanism. The method may include outputting, via the dispensing mechanism, a second cascading flow of tempered water onto the plurality of frozen food products to maintain the thermal gradient, wherein: a volume of the second cascading flow of tempered water replaces the first volume of tempered water as the first volume of tempered water exits the respective cascade tray.

### BRIEF DESCRIPTION OF THE FIGURES

Having thus described the embodiments of the disclosure in general terms, reference now will be made to the accompanying drawings, which are not necessarily drawn to scale, and wherein:

FIG. 1 shows a front perspective view of an example thawing system in accordance with some embodiments of the present disclosure;

FIG. 2 shows a front perspective view of the example thawing system in which some elements are omitted to permit view of other aspects of the thawing system;

FIG. 3 shows a rear perspective view of an example thawing system in accordance with some embodiments of the present disclosure;

FIG. 4 shows a side view of the example thawing system in accordance with some embodiments of the present disclosure;

FIG. 5 shows a top view of an example thawing system in accordance with some embodiments of the present disclosure;

FIGS. 6-8 show an example thawing system in operation in accordance with some embodiments of the present disclosure;

FIG. 9 shows a top perspective view of an example dispensing mechanism in accordance with some embodiments of the present disclosure;

FIG. 10 shows a side perspective view of an example dispensing mechanism in accordance with some embodiments of the present disclosure;

FIG. 11 shows a side view of an example dispensing mechanism in accordance with some embodiments of the present disclosure;

FIG. 12A shows a top view of an example dispensing mechanism in accordance with some embodiments of the present disclosure;

FIG. 12B shows a bottom view of an example dispensing mechanism in accordance with some embodiments of the present disclosure;

FIG. 12C shows a front view of an example dispensing mechanism in accordance with some embodiments of the present disclosure;

FIG. 12D shows a back view of an example dispensing mechanism in accordance with some embodiments of the present disclosure;

FIG. 13 shows a top perspective view of an example cascade tray in accordance with some embodiments of the present disclosure;

FIG. 14 shows a bottom perspective view of an example cascade tray in accordance with some embodiments of the present disclosure;

FIG. 15A shows a top view of an example cascade tray in accordance with some embodiments of the present disclosure;

FIG. 15B shows a bottom view of an example cascade tray in accordance with some embodiments of the present disclosure;

FIG. 15C shows a front view of an example cascade tray in accordance with some embodiments of the present disclosure;

FIG. 15D shows a side view of an example cascade tray in accordance with some embodiments of the present disclosure; and

FIG. 16 shows an example thawing system in accordance with some embodiments of the present disclosure.

### DETAILED DESCRIPTION

Some embodiments of the present invention will now be described more fully hereinafter with reference to the accompanying drawings, in which some, but not all, embodiments of the invention are shown. Like reference numerals refer to like elements throughout. Indeed, various embodiments of the invention may be embodied in many different forms and should not be construed as limited to the embodiments set forth herein. Rather, these embodiments are provided so that this disclosure will satisfy applicable legal requirements.

As used herein, the term “or” is used in both the alternative and conjunctive sense, unless otherwise indicated. The term “along,” and similarly utilized terms, means near or on, but not necessarily requiring directly on an edge or other referenced location. The terms “approximately,” “generally,” and “substantially” refer to within manufacturing and/or engineering design tolerances for the corresponding materials and/or elements unless otherwise indicated. Thus, use of any such aforementioned terms, or similarly interchangeable terms, should not be taken to limit the spirit and scope of embodiments of the present invention.

### Overview

In general, various embodiments of the present disclosure provide improved systems for thawing frozen food products. For purposes of describing and illustrating exemplary aspects of the thawing system, the proceeding description is presented in the context of thawing poultry products. It will be understood and appreciated that such context is provided by way of example and uses of the system in additional contexts, such as with other frozen products, are contemplated and within the scope of the invention.

In QSRs, distribution centers (DCs), and/or the like, frozen poultry products may be provided in the form of frozen bricks wrapped in a plastic overwrap. For example, individual chicken cutlets may be provided as frozen bricks sealed within a plastic overwrap. Historical approaches to thawing the bricks typically include placing the bricks into a thawing cabinet inside of which air is maintained at a thawing temperature. As previously described, such approaches may result in lengthy thawing times, which decreases efficiency of the restaurant. Increasing the air temperature inside the thawing cabinet may reduce thawing time; however, the increased temperature may adversely impact food taste and texture.

In various embodiments, the thawing system reduces thawing time without degrading food taste by using water cascading over the frozen bricks. As indicated above, thawing a frozen substance involves heat transfer from the ambient environment into the frozen substance. It is known that heat transfer within a liquid occurs much more quickly that within a gas. For example, submerging the frozen substance in water may result in a much lower thawing time as compared to exposing the frozen substance to ambient or even heated air.

For efficiency purposes, water-based thawing could further include continuous introduction of new frozen bricks into the water followed by submerging and transitioning the bricks through and ultimately out of the water via a forced-submersion convey method. However, the buoyancy of the wrapped frozen bricks reduces as brick temperature increases, thereby complicating forced submersion convey methods due to increasing difficulty of positively conveying and positionally controlling semi-buoyant or sinking bricks. For example, to move the frozen bricks through the water continuously, the bricks must be forcibly submerged and moved through the water under some manner of positive control. While the bricks are initially buoyant and, therefore, movable via a forced submersion convey method, the buoyancy is lost as the brick temperature rises. The loss of brick buoyancy may render the forced submersion convey method inoperable due to degradation in the ability to positively convey and positionally control the bricks. Additionally, mechanisms for forcibly submerging and translating bricks throughout water-immersion thawing may be bulky, overly complicated and, therefore, ill-suited to QSR cooking environments, industrial thawing operation environments, and/or the like. To overcome these challenges, various embodiments of the present thawing system combine the quicker heat transfer of liquid-based thawing with cascading water flows, continuous movement mechanisms, and individualized trays for partial brick submersion. In doing so, the cascade-based thawing system avoids a need to fully submerge the bricks in a water bath and provides positive conveyance and positional control throughout the thawing process.

### Example Thawing System

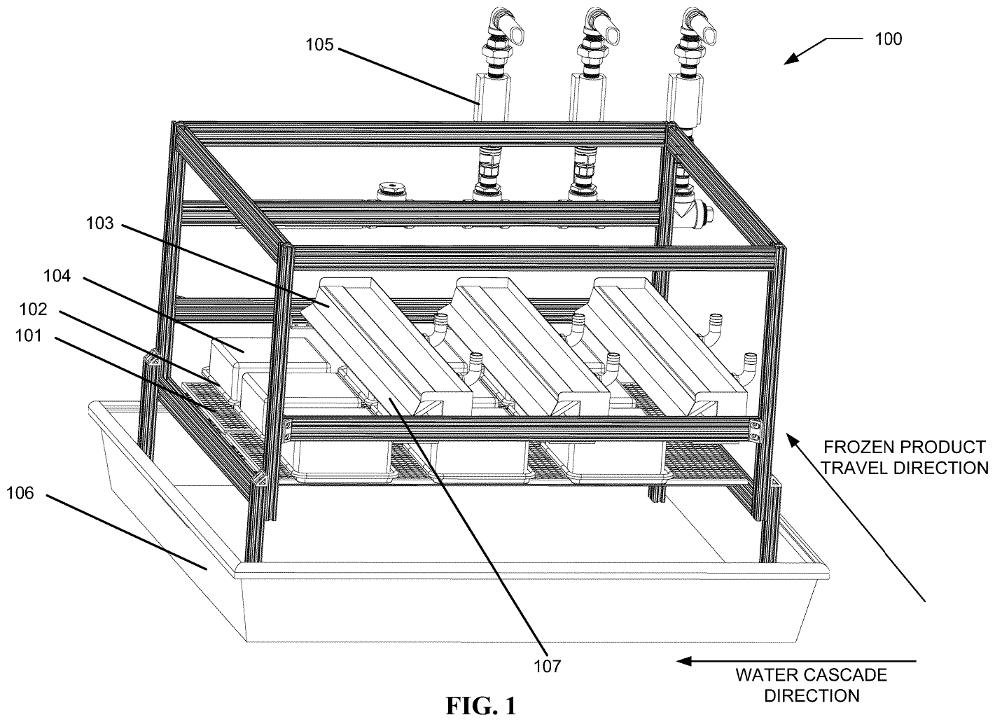

FIG. 1. Shows an example thawing system 100. In various embodiments, the thawing system 100 is configured to efficiently thaw a plurality of frozen products 104 using means for providing a cascading water flow onto the frozen products and means for continuously moving the frozen products along the cascading water flow. The thawing system 100 includes one or more continuous movement mechanisms 101 and one or more dispensing mechanisms 103. For example, the thawing system 100 may include a plurality of dispensing mechanisms 103 spaced apart from one another. A respective dispensing mechanism 103 may be positioned superior and extend parallel to a movement direction of a respect continuous movement mechanism 101. The thawing system 100 further includes cascade trays 102 for holding frozen products 104. For example, a wrapped, frozen brick may be placed onto a cascade tray 102. The cascade tray 102 may contain and support the frozen product 104 throughout processing through the thawing system 100. The dispensing mechanism 103 may be positioned superior to the continuous movement mechanism 101 such that the cascade trays 102 and frozen products 104 may be translated beneath a tempered, cascading water flow emitted from the dispensing mechanism 103.

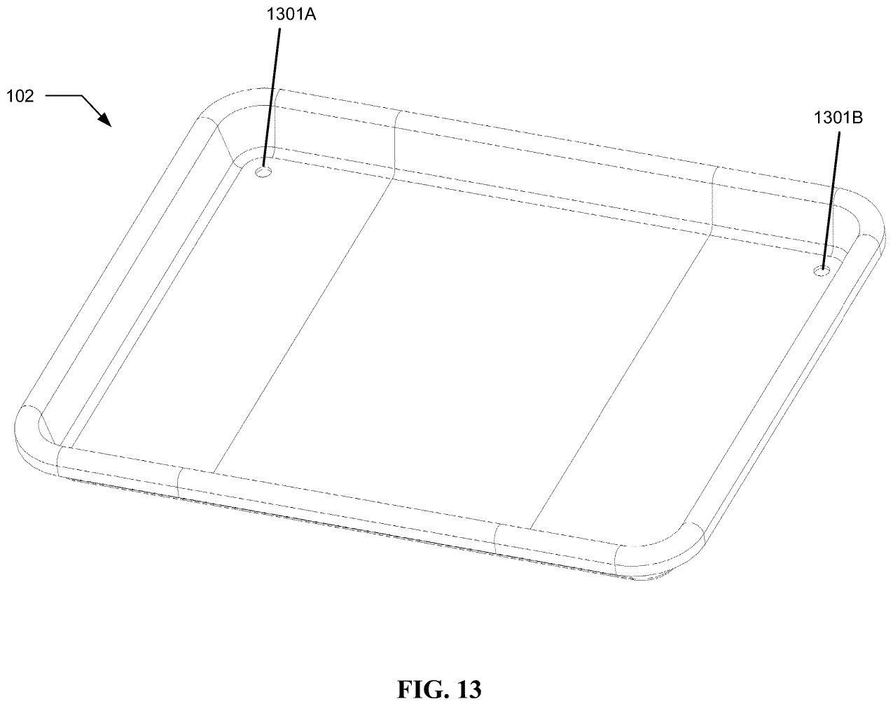

In various embodiments, the thawing system 100 dispenses cascading water over the frozen products 104 to induce thawing. The continuous cascading water transfers a large amount of heat to thaw the frozen product 104 by inducing a phase change in the freezing media of the frozen product (e.g., water, brine, marinade, and/or the like). For example, the continuous cascading water applied over a total or near-total surface area of the frozen product 104 may efficiently induce a change in enthalpy of frozen water within the product. For example, the cascading flow of tempered water may apply a thermal gradient to the frozen products 104 to induce thawing. Additionally, the cascade tray 102 provides a secondary reservoir for temporarily holding the water against the frozen product 104, which further improves the efficiency of thermal transfer. As further shown in FIGS. 13, 14, and 15A-B, the cascade tray 102 includes voids that permit passage of water out of the cascade tray 102, which avoids stagnation of water within the cascade tray and ensures continuous refresh of tempered supply water in the cascade tray. In various embodiments, the voids enable drainage of the cascade tray 102 and surrounding of the product with refrigerated air in the event that the temperature of thaw supply water exceeds setpoint thresholds.

In various embodiments, the cascading water and temporary water reservoir of the cascade tray 102 enables efficient thawing of the frozen product 104 without requiring excess thawing temperatures that may compromise the taste and texture of the frozen product. For example, the cascading water may apply a continuous thermal gradient to the frozen products, and the renewing water volume contained in the cascade tray may increase exposure of the frozen product to the thermal gradient. Additionally, the simultaneous and continuous thawing of multiple frozen products in-batch enables higher thawing throughput, which may better meet high volume thawing demands of QSRs and DCs as compared to previous approaches that rely on thawing cabinets. Further, the use of a continuous movement mechanism, such as a conveyor belt, cascaded supply water dispensing mechanism and the cascade trays 102 allow for elements of the thawing system to be oriented outside of the water bath, thereby avoiding complications of transporting buoyant product through the water path and potential introduction of contaminants into supply water. The cascade-based techniques also ensure that each frozen product is individually impacted by clean, tempered supply water, as opposed to typical approaches that implement a common water bath to thaw products collectively.

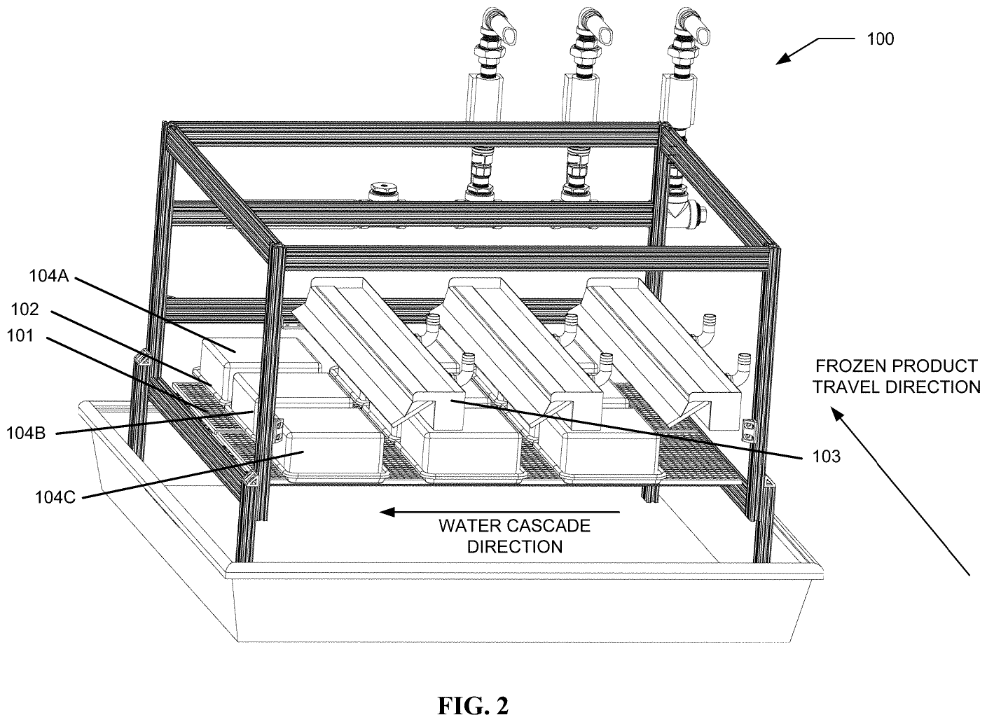

The continuous movement mechanism 101 is configured to support and move the cascade trays 102 to translate the frozen products 104 beneath the dispensing mechanism 103. The continuous movement mechanism 101 includes a translating surface, such as a belt, chain-link, or wire mesh, upon which the cascade trays 102 are placed and which includes a plurality of voids through which water may pass. For example, the continuous movement mechanism 101 may be a conveyor system including a porous belt upon which cascade trays 102 are placed. As the continuous movement mechanism moves the translating surface beneath cascading water from the dispensing mechanism 103, the cascade trays 102 translate in concert with the surface. The translating surface may be porous to permit passage of the water through the continuous movement mechanism 101 and/or cascade trays 102 into a catch pan 106 from which the water may be sanitized, reheated, and reprocessed into the dispensing mechanism 103. The catch pan 106 may also be referred to as a “reservoir” configured to collect outflow from the continuous movement mechanism 101. The continuous movement mechanism 101 may translate the cascade trays 102 and frozen product 104 in a direction perpendicular to the flow direction of the cascading water (see FIG. 2) or at another suitable angle offset from the flow direction (e.g., 15 degrees, 30 degrees, 45 degrees, or another suitable offset value). In some embodiments, the continuous movement mechanism 101 includes one or more vibration mechanisms configured to vibrate the surface of the continuous movement mechanism 101 to further induce heat transfer into the frozen products, which may further improve thawing efficiency. The sonication mechanism may be configured to vibrate individual cascade trays or groupings of cascade trays to provide for targeted heat transfer acceleration such that thawing may be standardized across all frozen products being processed.

The dispensing mechanism 103 is configured to receive tempered supply water from a manifold 105 via tubing (not shown). The dispensing mechanism 103 includes a deflection panel 107 along which the tempered supply water is dispensed and from which the tempered supply water cascades onto the frozen products 104. For example, the deflection panel 107 may receive and deflect a tempered water flow in a direction that is oblique to the movement direction of the continuous movement mechanism 101. Further, the tempered water flow may impact the frozen products 104 at an oblique angle, flowing across the frozen products onto the respective cascade trays 102. The dispensing mechanism 103 includes one or more dispensing surfaces configured to distribute the tempered supply water such that the tempered supply water evenly flows onto rows of cascade trays 102. In some embodiments, the tempered supply water impacts the frozen products and cascade trays under turbulent flow, which may improve the efficiency of thermal transfer between the water and frozen products. The flow rate of the tempered supply water through the manifold 105 and dispensing mechanism 103 may be regulated to ensure sufficient distribution onto the deflection panel 107. For example, tempered supply water may be pumped through the thawing system at a flow rate of 3.5 gallons per minute (GPM) (or another suitable rate value) to provide 0.5 GPM per inch of linear flow area along the deflection panel 107.

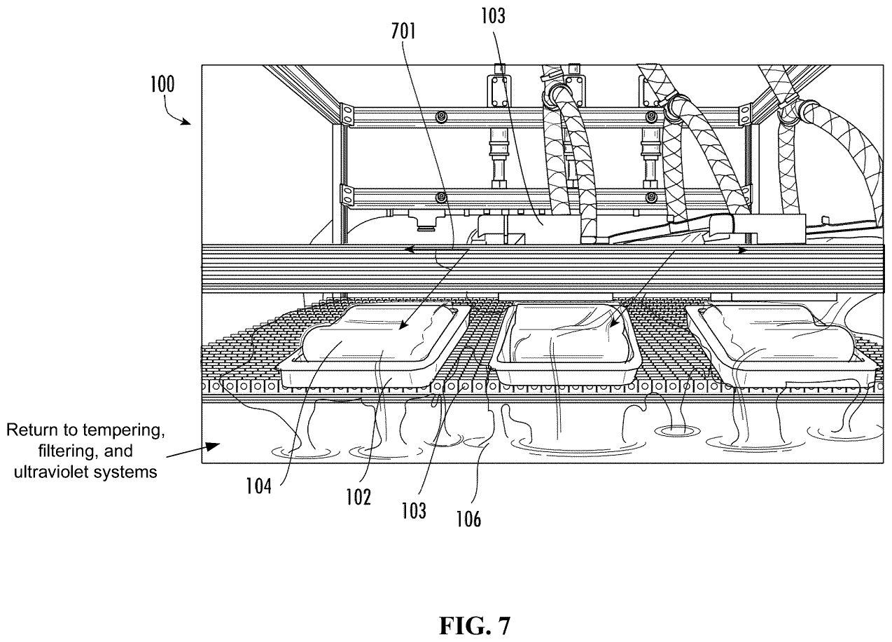

The deflection panel 107 is angled to provide an oblique impact angle for cascading the tempered supply water onto the frozen products 104 and cascade trays 102 (see oblique impact angle 701 shown in FIG. 7). For example, the deflection panel 107 may be configured to direct the tempered water flow onto a row of frozen products at an oblique angle of impact and in a direction that is orthogonal to the movement direction of the continuous movement mechanism 101. The oblique impact angle may advantageously improve rapid and efficient transfer of heat from the water to the frozen product 104 by ensuring that the water flows quickly over the frozen product 104 and does not splash off or become stagnant atop the frozen product. The oblique impact angle may maximize surface coverage and unidirectional flow over the frozen product 104. Additionally, in some embodiments, the dispensing mechanism 103 is positioned off-center from the frozen products 104 and cascade trays 102 in their direction of travel. For example, a respective dispensing mechanism may be positioned off-center from a respective centerline of a row of cascade trays. As water impacts the frozen product 104, the off-center position of the dispensing mechanism 103 causes the water to flow along the frozen product 104, which may push sitting water off the frozen product 104 and into the cascade tray 102. The continuous flow of water over the top of the frozen product 104 may improve thermal transfer efficiency and prevent stagnation of cooled water atop the frozen product 104.

FIG. 2 shows a front perspective view of the thawing system 100 in which some elements are omitted to permit view of other aspects. The thawing system 100 may simultaneously thaw a plurality of frozen products 104A, 104B, 104C via the same dispensing mechanism 103. For example, a row of frozen products 104A, 104B, 104C may be placed on respective cascade trays 102 and arranged in a row along the continuous movement mechanism 101 and off-center from a dispensing mechanism 103. The continuous movement mechanism 101 translates the cascade trays longitudinally along a cascading water flow dispensed from the dispensing mechanism 103. As the cascade trays are translated, the frozen products 104A, 104B, 104C receive a continuous impact of cascading water, which transfers thermal energy to the frozen product to induce thawing. For example, the perpendicular travel direction of the cascade trays 102 and frozen products 104 to the supply water flow direction ensures that the frozen products remain in continuous contact with the cascading supply water throughout the entirety of the thawing process, which may further improve thermal transfer efficiency. By simultaneously thawing multiple frozen products, the thawing system 100 may provide sufficient throughput to meet the high-volume food demands of QSR environments, DC environments, and/or the like. Additionally, the movement of the cascade trays through the thawing system 100 allows for thawed products to be removed from the thawing system 100 and additional frozen products added to the thawing system 100 without suspending thawing processes. Such aspects are advantageous over previous approaches where frozen and thawed products must be periodically cycled into and out of a thawing cabinet, thereby causing inefficient downtime in thawing processes.

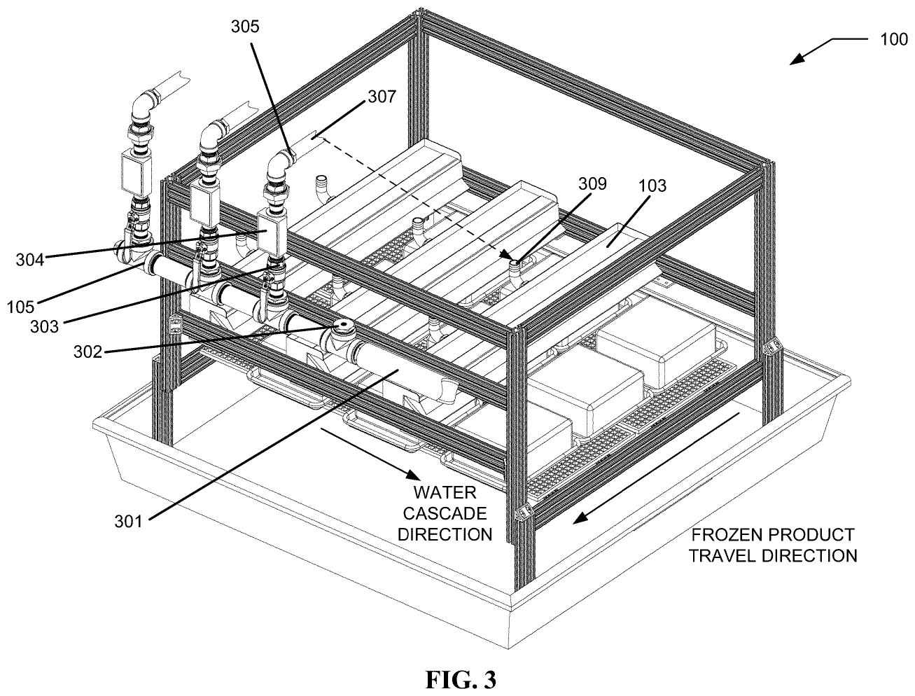

FIG. 3 shows a rear perspective view of the thawing system 100. The manifold 105 includes an inlet 301 for receiving a supply of tempered supply water. For example, via the inlet 301, the manifold 105 receives a constant supply of water heated to 39.5 degrees Fahrenheit, or another suitable thawing temperature. In some embodiment, the manifold 105 includes a probe well 302 from which temperature of the supply water may be measured. The manifold 105 includes a plurality of distribution branches 303 that each supply water to a respective dispensing mechanism 103. The distribution branch 303 may include a flow meter 304 configured to control the flow rate of supply water through the distribution branch 303 and dispensing mechanism 103. The flow meter 304 may be used to optimize the flow rate based on thawing factors such as frozen product type, frozen product geometry, and desired thawing time. In embodiments of the invention, the thawing time can be reduced to 12 hours.

The distribution branch 303 includes an outlet 305 through which supply water may flow to the dispensing mechanism 103 via flexible tubing 307 (partially shown). The dispensing mechanism 103 may include one or more inlets 309 for receiving the supply water from the flexible tubing 307. For example, the flexible tubing 307 may branch into two or more portions that are each connected to a respective inlet 309. Alternative arrangements for directing flow of the supply water from the outlet 305 to the inlet 309 are also contemplated. For example, an embodiment of the thawing system 100 may include fixed piping for directing the supply water from the outlet 305 to the inlet 309.

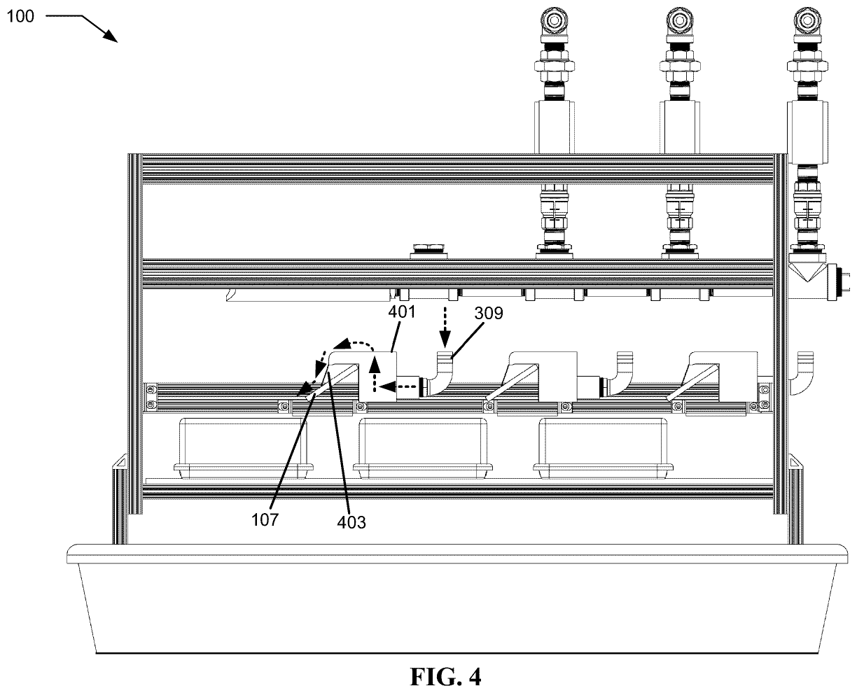

FIG. 4 shows a side view of the example thawing system 100. Arrow indicia indicate an example flow direction of supply water through the dispensing mechanism 103. As indicated, the supply water may flow through the inlet 301 into a reservoir 401. The supply water may flow from the reservoir 401 onto a flow panel 403. The supply water may flow from the flow panel 403 onto the deflection panel 107 and further onto the frozen product. In various embodiments, the flow of supply water along the flow panel 403 and deflection panel 107 ensures that the supply water fully envelopes the frozen product as compared to a more narrowly distributed flow that splashes onto and away from the frozen product. The deflection panel 107 also directs the supply water flow onto the frozen product at an oblique angle, which is further shown in FIG. 7.

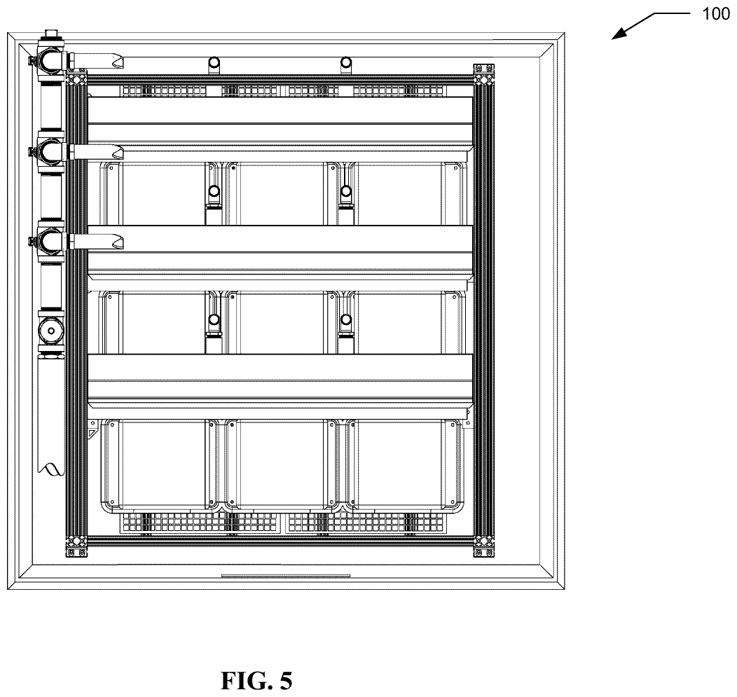

FIG. 5 shows a top view of the thawing system 100.

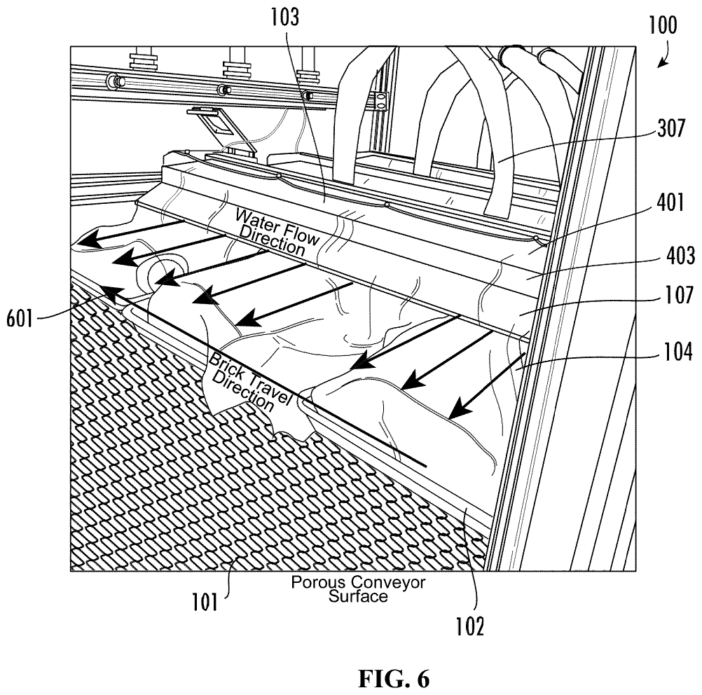

FIG. 6 shows the example thawing system 100 in operation. As shown, the supply water flows through the flexible tubing 307 into the dispensing mechanism 103. The supply water flows through the dispensing mechanism 103 upwards into the reservoir 401. From the reservoir 401, the supply water travels across a flow panel 403 onto a deflection panel 107. The deflection panel 107 directs the supply water to cascade onto and contact the frozen product 104 and cascade tray 102 at an oblique angle relative to a plane extending along the surface of the continuous movement mechanism 101. For example, the flow of tempered supply water may be emitted toward the surface of the continuous movement mechanism 101 in a direction that is oblique to the travel direction of the continuous movement mechanism 101 (also referred to as a “movement direction”). In doing so, the tempered water flow may impact the frozen food product in a direction such that the water flows obliquely over the frozen food products 104. The travel direction of the cascade tray 102, and frozen product 104 disposed thereon, may be orthogonal to the flow direction of the supply water. For example, the continuous movement mechanism 101 may translate cascade trays and frozen products longitudinally along the dispensing mechanism 103 in the direction indicated by arrow 601.

As the supply water cascades off the frozen product 104, the cascade tray 102 floods, thereby partially submerging the frozen product 104. The partial submersion of the frozen product 104 in the supply water provides a source of thermal transfer in addition to the thermal transfer that occurs as the supply water cascades and flows over the frozen product 104. The cascade tray 102 includes a plurality of voids that allow the supply water to flow out the bottom of the cascade tray 102, thereby allowing the collected water in the cascade tray to be continuously refreshed throughout the thawing process. For example, the cascade tray may temporarily contain and release respective volumes of the tempered water flow from the dispensing mechanism 103. The continuous replacement of the volume of supply water contained in the cascade tray 102 may avoid stagnation and improve thawing efficiency by ensuring that the frozen product 104 undergoes continuous partial submersion in suitably tempered supply water (e.g., whereas stagnant water in the cascade tray 102 would otherwise cool and reduce thawing efficiency over time).

FIG. 7 further depicts the example thawing system 100 in operation. The dispensing mechanism 103 causes an oblique impact angle 701 between the frozen product 104 and the supply water. In some embodiments, the dispensing mechanism 103 and flow rate of the supply water are configured to provide an oblique impact angle 701 of about 35-55 degrees. The oblique impact angle 701 causes the supply water to flow rapidly over the frozen product 104 as opposed to splashing against and stagnating atop the frozen product 104, which may occur in instances of a direct (e.g., 90 degree) impact angle. As shown, the flow rate of supply water from the dispensing mechanism 103 and flow rate of the supply water out of the cascade tray 102 are optimized such that the cascade tray 102 is continuously flooded, causing partial submersion of the frozen product 104 throughout the thawing process. The flow rate of supply water from the dispensing mechanism 103 and the dimensions of the cascade tray 102 (e.g., including voids for releasing the supply water) are optimized to cause partial submersion of the frozen product 104 without causing the frozen product 104 to float in the flooded cascade tray. The partial submersion of the frozen product 104 without flotation allows the cascade tray 102 and frozen product 104 to be translated through the thawing system 100 in a stable and continuous fashion.

The catch pan 106 collects the supply water that flows through the cascade tray 102 and continuous movement mechanism 101. From the catch pan 106 the supply water may be further pumped through one or more treatment apparatuses for filtering, antimicrobial processing, and reheating. For example, the supply water may be pumped through a filtering apparatus that isolates particulate matter from the supply water. The filtered supply water may be further pumped through an ultraviolet-based apparatus and/or other antimicrobial system that sterilizes the supply water. Following filtration and sterilization, the supply water may be pumped through a heating apparatus that tempers the supply water to a suitable thawing temperature. The tempered supply water generated by the heating apparatus may be recirculated through the thawing system 100 (e.g., via one or more manifolds 105, pumps, and/or the like). In some embodiments, a supply water recirculation mechanism of the thawing system 100 includes one or more probe wells by which the supply water may be monitored for hazardous materials (e.g., toxins, bacteria, lead, and/or the like) via one or more sensors. For example, during the thawing process, the supply water may be monitored to detect excess levels of bacteria, which may indicate a contaminated batch of product, contamination of the thawing system, and/or the like.

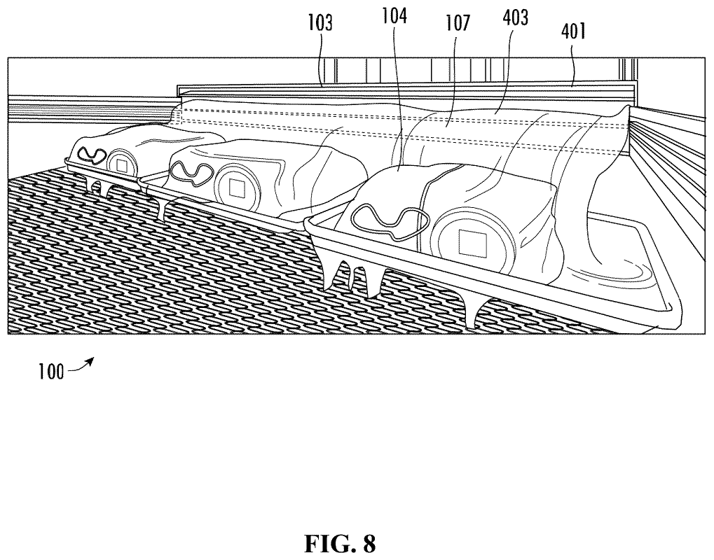

FIG. 8 further illustrates the thawing system 100 in operation. As shown, the supply water flows from the reservoir 401 and cascades onto a flow panel 403 that further directs the supply water onto the deflection panel 107. The deflection panel 107 is oriented such that the supply water cascades onto a plurality of frozen products 104 at an oblique impact angle. In some embodiments, the flow panel 403 demonstrates a different slope relative to the slope of the deflection panel 107. For example, the flow panel 403 may include a first slope and the deflection panel 107 may include a second slope that is less than the first slope.

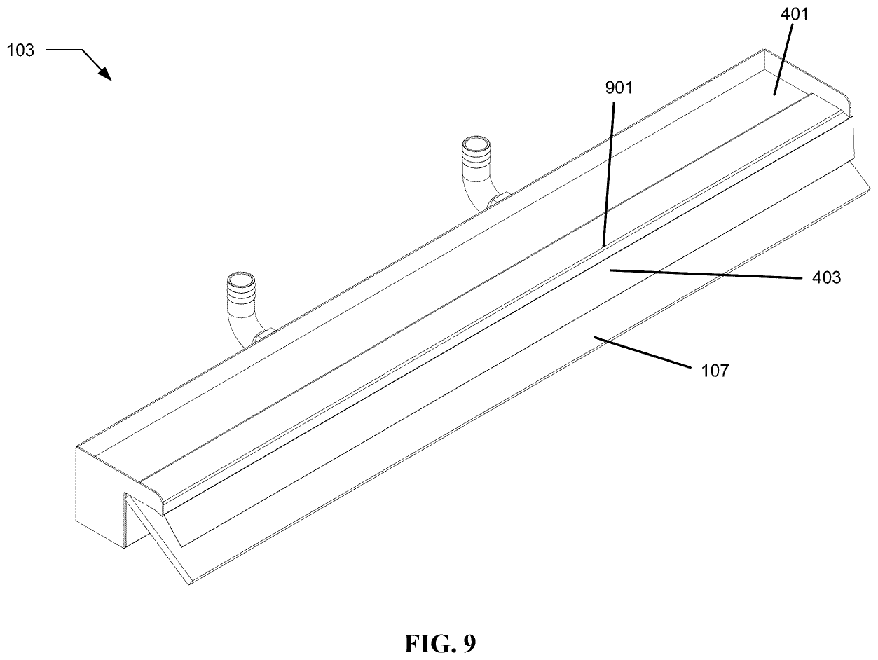

FIG. 9 shows a top perspective view of the dispensing mechanism 103. The reservoir 401 includes a lip 901 that defines a convex transition between the top surface of the reservoir 401 and the flow panel 403. The convex transition acts as a flow surface for distributing and directing supply water from the reservoir onto the flow panel 403. For example, when the reservoir 401 fills with supply water to a volume such that the height of the water reaches the top surface of a sidewall of the reservoir 401, excess water may flow along and over the lip 901 onto the flow panel 403. The flow panel 403 directs the flow of supply water onto the deflection panel 107. The deflection panel 107 further directs the flow of the supply water onto frozen product at an oblique angle. Although illustrated as separate panels, alternate embodiments may provide the flow panel 403 and deflection panel 107 as a single flat or curved panel that is proximate to the lip 901 and configured to direct the flow of supply water onto frozen products at an oblique angle.

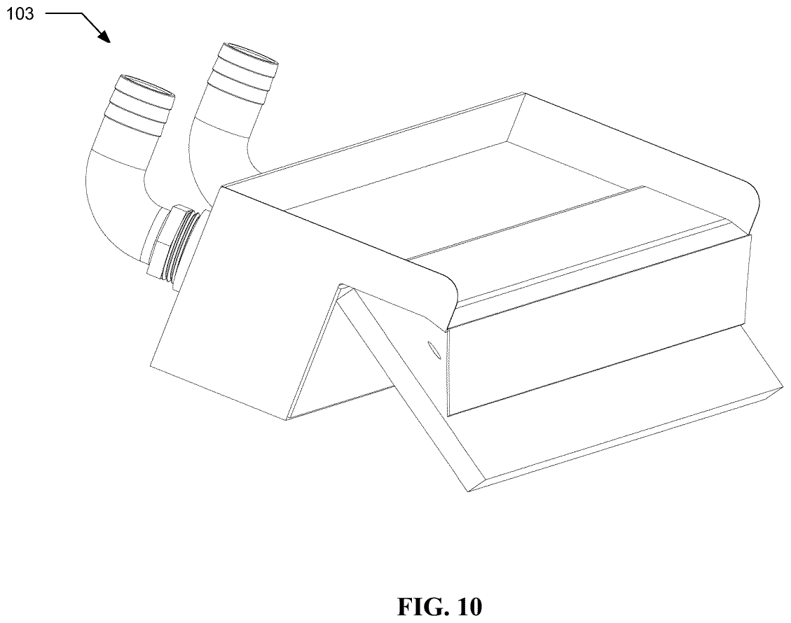

FIG. 10 shows a side perspective view of the dispensing mechanism 103.

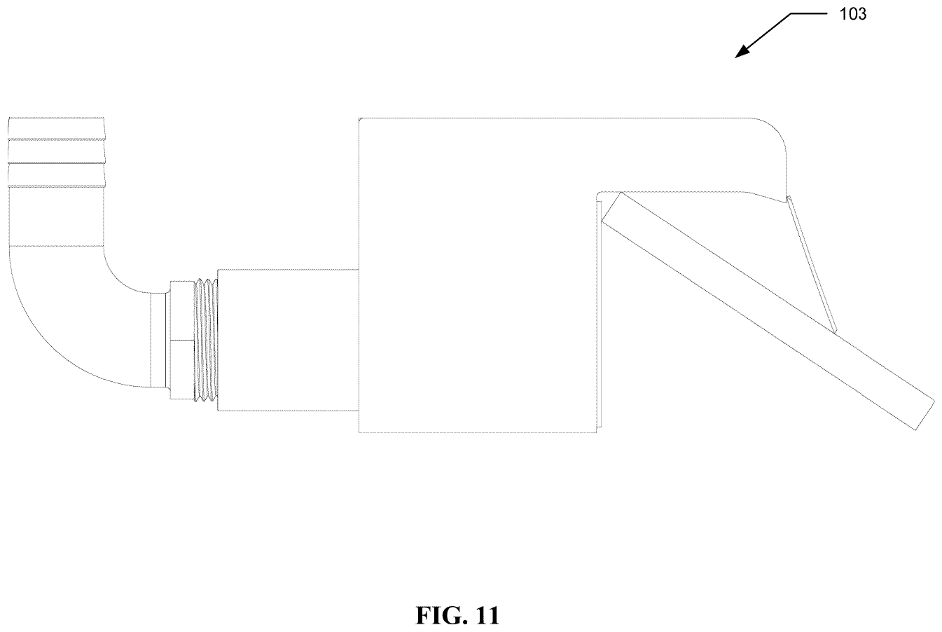

FIG. 11 shows a side view of the dispensing mechanism 103.

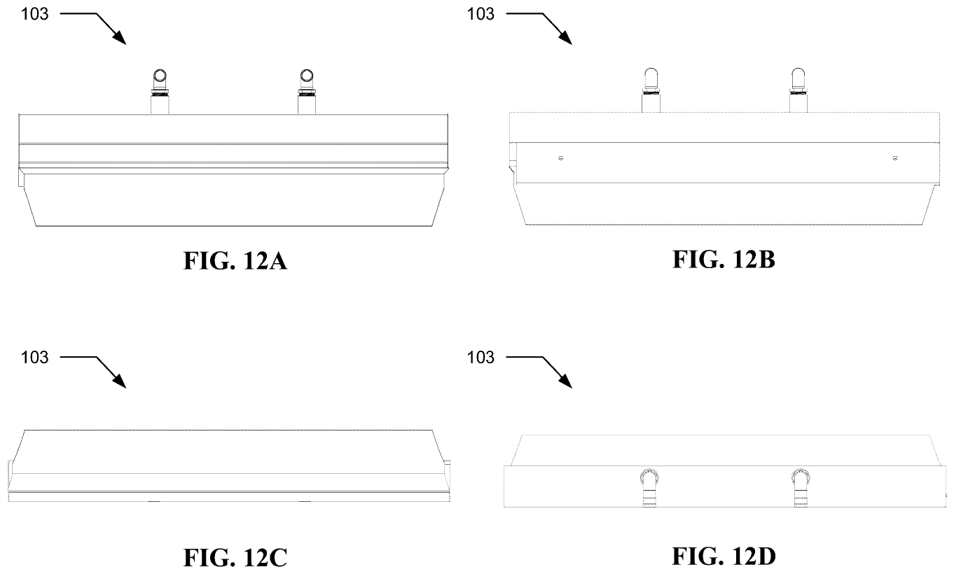

FIG. 12A shows a top view of the dispensing mechanism 103.

FIG. 12B shows a bottom view of the dispensing mechanism 103.

FIG. 12C shows a front view the dispensing mechanism 103.

FIG. 12D shows a back view of the dispensing mechanism 103.

FIG. 13 shows a top perspective view of a cascade tray 102. The cascade tray 102 may include a plurality of voids 1301A, 1301B that permit flow of supply water through the cascade tray 102. The voids enable continuous refreshment of tempered supply water in the cascade tray 102, which may improve thermal transfer efficiency throughout the thawing process by avoiding partial submersion of frozen products in cooled, stagnant supply water. The dimensions of the cascade tray 102 are configured to accommodate a frozen product, such as a frozen chicken filet, and/or the like. The flow rate of the thawing system and dimensions of the cascade tray 102, including the voids 1301A, 1301B, are configured such that the cascade tray 102 fully floods with supply water throughout the thawing process without causing a frozen product held thereon to become buoyant. The avoidance of buoyancy may improve stability of the frozen product on the cascade tray 102 such that the cascade tray 102 may be translated through the thawing system without the frozen product sliding out of the cascade tray 102.

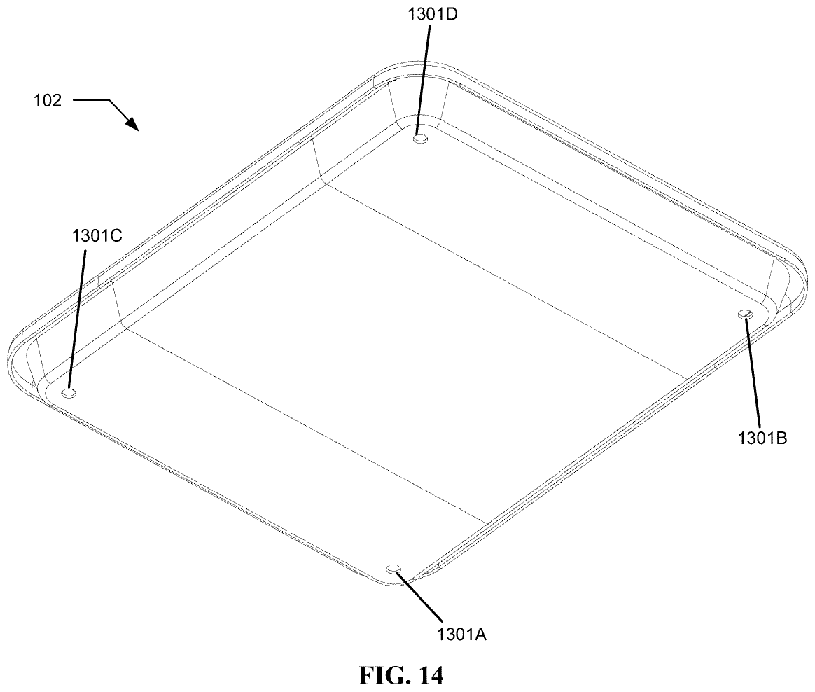

FIG. 14 shows a bottom perspective view of the cascade tray 102. As shown, the voids 1301A, 1301B, 1301C, 1301D extend fully through the top and bottom surfaces of the cascade tray 102. The example cascade tray 102 shown in FIGS. 13, 14, and 15A-D include four voids. Other embodiments of the cascade tray 102 may include additional voids. For example, additional voids may be included in instances where the flow rate of the supply water onto the frozen product and cascade tray is increased, which may further improve thawing efficiency but require a greater capacity to dispel water from the cascade tray 102 to avoid buoyancy of the frozen product. In some embodiments, the voids of the cascade tray 102 are positioned along the corners and/or perimeter of the bottom tray surface to avoid the frozen product blocking passage of water through the cascade tray and maximize contact between the water and the bottom surface of the frozen product. Additionally, the arrangement of the voids along the perimeter of the cascade tray may reduce a likelihood of void edges directly contacting and tearing the wrapping of the frozen product. In some embodiments, the cascade tray 102 includes a textured bottom surface that resists slippage of the cascade tray 102 along the continuous movement mechanism of the thawing system. For example, the textured bottom surface may increase friction between the cascade tray and the surface of the continuous movement mechanism.

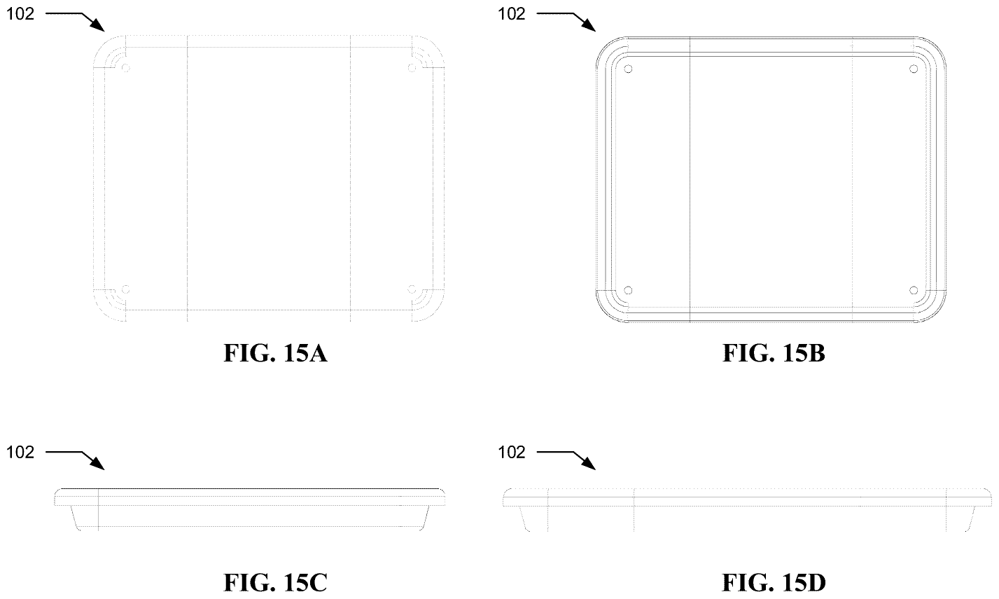

FIG. 15A shows a top view of the cascade tray 102.

FIG. 15B shows a bottom view of the cascade tray 102.

FIG. 15C shows a front view of the cascade tray 102.

FIG. 15D shows a side view of the cascade tray 102.

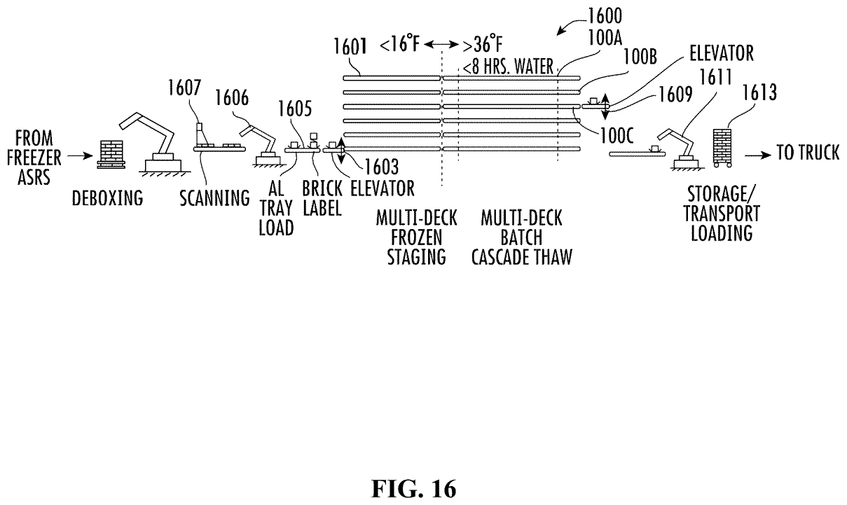

FIG. 16 shows an example thawing system 1600. In some embodiments, the thawing system 1600 includes a plurality of thawing systems oriented into a stack or tower for spatial efficiency. For example, the thawing system 1600 may include a plurality of thawing systems 100A, 100B, 100C that are vertically oriented atop each other to further accommodate high-volume, high throughput thawing needs in a minimal footprint, which may be advantageous in QSR environments, DC environments, and/or the like where space is limited.

The thawing system 1600 may receive frozen products from a staging system 1601 configured to hold cascade trays and frozen products disposed thereon in a sufficiently cold environment to preserve freezing. The staging system 1601 may include a movement apparatus that translates the cascade trays and frozen products onto a continuous movement mechanism of a respective thawing system 100A, 100B, 100C. For example, the staging system 1601 may include a vertically oriented stack of conveyor belts onto which cascade trays holding frozen products are placed. As the thawing system 1600 processes frozen products along the continuous movement mechanism of each thawing system 100A, 100B, 100C, the conveyor belts of the staging system 1601 may continuously introduce additional cascade trays and frozen products into the thawing systems 100A, 100B, 100C for thawing.

The staging system 1601 may be loaded via an elevator 1603. The elevator 1603 may lift cascade trays loaded with frozen products to a continuous movement mechanism and translate the cascade trays onto the continuous movement mechanism. The continuous movement mechanism may translate the frozen products along one or more segments of a dispensing mechanism, the segments being continuous (e.g., outputted from a single reservoir 401) or discontinuous (e.g., outputted from different reservoirs 401 spaced along the dispensing mechanism in the travel direction of the continuous movement mechanism). In some embodiments, a plurality of frozen products may be organized into rows, and respective rows may be translated underneath cascading water flows from different dispensing mechanisms spaced apart from one another.

The elevator 1603 may receive the cascade trays and frozen products for loading from one or more pre-processing elements. For example, the elevator 1603 may receive cascade trays from a labeling apparatus 1605 that applies labels onto the frozen products, the labels including product information such as product identifier, product name, weight, volume, and/or the like. The labeling apparatus 1605 may receive the cascade trays from a loading apparatus 1606 that disposes individual frozen products onto respective cascade trays. In some embodiments, prior to loading, a scanning apparatus 1607 scans the frozen products to detect product flaws, such as breached wrappings, excess temperature, contaminants, and/or the like. Additionally, or alternatively, the scanning apparatus 1607 may scan frozen products to obtain product information (e.g., by recognition or reading of an existing label), such as product identifier, product name, volume, and/or the like. In some embodiments, the thawing system 1600 (or individual thawing systems 100A, 100B, 100C thereof) may be configured based on the product information. For example, factors such as supply water flow rate, supply water temperature, continuous movement mechanism speed, cascade tray void size, and/or the like, may be increased or decreased based on the type of product being thawed, product geometry, desired thawing time, and/or the like.

A second elevator 1609 may receive and unload cascade trays and thawed products from the thawing system 1600. For example, the second elevator 1609 may ascend and descend to receive cascade trays and thawed products from the continuous movement mechanisms of the thawing systems 100A, 100B, 100C. A second loading apparatus 1611 may retrieve the thawed products from the cascade trays and place the thawed products into a storage apparatus 1613. In various embodiments, the first elevator 1603, second elevator 1609, and/or the like may include continuous movement mechanisms (e.g., conveyors, pushers, hooks, graspers, and/or the like) configured to translate cascade trays across the respective elevator surfaces and advance the cascade trays onto or off of the surface of continuous movement mechanisms of the thawing systems.

While various aspects have been described, additional aspects, features, and methodologies of the claimed apparatuses will be readily discernible from the description herein, by those of ordinary skill in the art. Many embodiments and adaptations of the disclosure and claimed inventions other than those herein described, as well as many variations, modifications, and equivalent arrangements and methodologies, will be apparent from or reasonably suggested by the disclosure and the foregoing description thereof, without departing from the substance or scope of the claims. Furthermore, any sequence(s) and/or temporal order of steps of various processes described and claimed herein are those considered to be the best mode contemplated for carrying out the claimed inventions. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the claimed inventions. In addition, some steps may be carried out simultaneously, contemporaneously, or in synchronization with other steps.

The embodiments were chosen and described in order to explain the principles of the claimed inventions and their practical application so as to enable others skilled in the art to utilize the inventions and various embodiments and with various modifications as are suited to the particular use contemplated. Alternative embodiments will become apparent to those skilled in the art to which the claimed inventions pertain without departing from their spirit and scope. Accordingly, the scope of the claimed inventions is defined by the appended claims rather than the foregoing description and the exemplary embodiments described therein.

What is claimed is:

1. A thawing system, comprising:
at least one movement mechanism comprising a surface configured to receive a plurality of cascade trays, wherein:
the at least one movement mechanism is configured to translate the plurality of cascade trays under a tempered water flow; and
a respective cascade tray is configured to accommodate a frozen food product, the tempered water flow configured to induce thawing of the frozen food product; and
at least one dispensing mechanism positioned superior to the at least one movement mechanism and configured to emit the tempered water flow toward the surface of the at least one movement mechanism in a direction that causes the tempered water flow to impact the frozen food product in a direction such that the water moves oblique to a movement direction of the at least one movement mechanism.

2. The thawing system of claim 1, wherein:
the at least one dispensing mechanism comprises at least one panel configured to receive and deflect the tempered water flow in the direction oblique to the movement direction of the at least one movement mechanism.

3. The thawing system of claim 2, wherein:
the at least one panel is configured to cause the tempered water flow to contact the plurality of frozen products at an oblique angle relative to a plane extending along the surface of the at least one movement mechanism.

4. The thawing system of claim 3, wherein:
the at least one panel comprises:
a flow panel configured to:
receive the tempered water flow; and
direct the tempered water flow onto a deflection panel; and
the deflection panel configured to direct the tempered water flow onto the plurality of frozen products at the oblique angle.

5. The thawing system of claim 4, wherein:
the flow panel comprises a first slope; and
the deflection panel comprises a second slope that is less than the first slope.

6. The thawing system of claim 2, wherein:
the at least one dispensing mechanism comprises a reservoir configured to temporarily contain a volume of the tempered water flow; and
the at least one panel is configured to receive the tempered water flow from the reservoir as the volume of the tempered water flow rises above a top surface of a sidewall of the reservoir.

7. The thawing system of claim 6, wherein:
the top surface of the sidewall comprises a lip configured to define a convex transition from the top surface to the at least one panel.

8. The thawing system of claim 1, wherein:
wherein a respective dispensing mechanism is positioned off-center from a respective centerline of at least a subset of the plurality of cascade trays to cause the tempered water flow to translate along respective top surfaces of the plurality of frozen food products.

9. The thawing system of claim 1, wherein:
the at least one movement mechanism comprise a chain-link conveyor belt.

10. The thawing system of claim 1, wherein:
the surface of the at least one movement mechanism comprises a plurality of voids and is configured to enable the tempered water flow to pass through the at least one movement mechanism via the plurality of voids.

11. The thawing system of claim 1, wherein:
a respective cascade tray defines a reservoir configured to temporarily containing a volume of water from the tempered water flow.

12. The thawing system of claim 11, wherein:
the cascade tray comprises a plurality of voids configured to enable passage of the volume of water through a bottom surface of the cascade tray such that additional volumes of water from the tempered water flow are temporarily contained within the reservoir.

13. The thawing system of claim 12, wherein:
the plurality of voids are distributed along a perimeter of the bottom surface of the cascade tray.

14. The thawing system of claim 12, wherein:
the bottom surface of the cascade tray comprises a first side configured to contact the respective frozen food product and a second side configured to contact the surface of the at least one movement mechanism; and
the second side comprises at least one textured feature configured to increase friction between the cascade tray and the surface of the at least one movement mechanism.

15. The thawing system of claim 1, further comprising:
a reservoir beneath the at least one movement mechanism and configured to collect an outflow of the tempered water flow;
an outlet configured to connect the outflow of the tempered water flow to a filtration system configured to output a filtered water supply to a heating apparatus;
the heating apparatus configured to generate tempered supply water from the filtered water supply; and
a manifold configured to generate the tempered water flow and circulate the tempered water flow to the at least one dispensing mechanism.

16. The thawing system of claim 1, wherein:
a respective dispensing mechanism comprises a plurality of outlets spaced apart from one another, a respective outlet being configured to direct a subset of the tempered water flow toward a subset of the surface of the at least one movement mechanism.

17. The thawing system of claim 1, further comprising:
a first elevator proximate to a first end of the at least one movement mechanism and configured to:
receive at least one frozen food product;
raise or lower the at least one frozen food product to a horizontal position in alignment with the surface of the at least one movement mechanism; and
translate the at least one frozen food product onto the surface of the at least one movement mechanism.

18. The thawing system of claim 1, further comprising:
a second elevator proximate to a second end of the at least one movement mechanism and configured to, subsequent to thawing of the at least one frozen food product via the tempered water flow:
receive the at least one thawed food product from the at least one movement mechanism;
raise or lower the at least one thawed food product to a horizontal position in alignment with a surface a storage apparatus; and
translate the at least one thawed food product onto the surface of the storage apparatus.

19. The thawing system of claim 1, wherein:
the at least one dispensing mechanism comprises a plurality of dispensing mechanisms spaced apart from one another along an axis extending parallel to a movement direction of the at least one movement mechanism.

20. A method for thawing frozen food products, comprising:
advancing a plurality of cascade trays beneath a first segment of a dispensing mechanism via a movement mechanism, wherein a respective cascade tray comprises a frozen food product;
outputting, via the dispensing mechanism, a cascading flow of tempered water onto the plurality of frozen food products and the plurality of cascade trays, wherein:
the cascading flow of tempered water is configured to apply a thermal gradient the plurality of frozen products to induce thawing;
the respective cascade tray is configured to temporarily contain a first volume of the tempered water; and
the first volume of tempered water is configured to increase exposure of a respective frozen food product to the thermal gradient;
advancing the plurality of cascade trays beneath a second segment of the dispensing mechanism via the movement mechanism; and
outputting, via the dispensing mechanism, a second cascading flow of tempered water onto the plurality of frozen food products to maintain the thermal gradient, wherein:
a volume of the second cascading flow of tempered water replaces the first volume of tempered water as the first volume of tempered water exits the respective cascade tray.
